(19) United States
(12) Patent Application Publication
(10) Pub. No.: US 2022/0348285 A1
(43) Pub. Date: Nov. 3, 2022

(54) BRAKE DEVICE FOR A VEHICLE, AND VEHICLE WITH BRAKE DEVICE

(71) Applicant: Schaeffler Technologies AG & Co. KG, Herzogenaurach (DE)

(72) Inventors: Alan BARRERA, Karlsruhe (DE); Philippe WAGNER, Souffelweyersheim (FR); Doris Maria WIMMER, Ottenhöfen (DE); Simon ORTMANN, Baden-Baden (DE); Aurelien GRAUSS, Mommenheim (FR)

(73) Assignee: Schaeffler Technologies AG & Co. KG, Herzogenaurach (DE)

(21) Appl. No.: 17/762,117

(22) PCT Filed: Aug. 21, 2020
(86) PCT No.: PCT/DE2020/100732

§ 371 Date: Mar. 21, 2022

(30) Foreign Application Priority Data
Sep. 20, 2019 (DE) 10 2019 125 391.8

(51) Int. Cl. B62L 1/10; B62K 3/00; B62L 3/02; F16D 55/225

(52) U.S. Cl. CPC B62L 1/10; B62K 3/002; B62L 3/023; F16D 55/225; B62K 2202/00; B62K 2204/00; F16D 2065/789

(57) ABSTRACT

A brake device for a vehicle with at least one wheel, wherein the wheel defines a rotational axis, with a brake body device for the transmission of a brake force to the wheel, with a concentric brake cylinder for the generation of the brake force. The brake cylinder has an inner housing part for radial support on a wheel axle of the wheel and an outer housing part for axial support on the brake body device. The two housing parts can be moved relative to one another, and a pressure chamber which runs around the rotational axis is formed between the two housing parts. The brake device has an insulation device for the thermal insulation of the brake body device in the direction of the brake cylinder. The insulation device is arranged at least axially between the outer housing part and the brake body device.

### CROSS-REFERENCE TO RELATED APPLICATIONS

This application is the U.S. National Phase of PCT Appln. No. PCT/DE2020/100732, filed Aug. 21, 2020, which claims priority from German Patent Application No. DE 10 2019 125 391.8, filed Sep. 20, 2019, the entire disclosures of which are incorporated by reference herein.

### TECHNICAL FIELD

The disclosure relates to a brake device for a vehicle. Further, the disclosure relates to a vehicle having the brake device.

### BACKGROUND

It is known to use disc or drum brakes in small, two-wheeled vehicles such as push scooters, scooters or even bicycles, to brake a wheel of the small vehicle.

For example, publication DE 200 16 878 U1 describes a push scooter having a brake apparatus designed as a hydraulically activatable disc brake. The brake apparatus comprises a brake disc connected to a wheel in a non-rotatable manner and a brake caliper fixed to the frame of the pedal scooter, wherein the brake caliper contains brake pads acting on the brake disc.

### SUMMARY

It is the object of the disclosure to create a brake device of the type mentioned at the outset, which is distinguished by a particularly high operational reliability. It is also an object of the disclosure to propose a vehicle having the brake device.

This object is achieved by a brake device having one or more of the features disclosed herein and by a vehicle having one or more of the features disclosed herein. Preferred or advantageous embodiments result from the claims, the following description, and the attached figures.

The disclosure relates to a brake device which is designed and/or suitable for a vehicle having at least one wheel. In particular, the brake device serves as a service brake for braking the wheel during driving operation. Optionally, however, the brake device can also serve as a parking brake when the vehicle is stationary. The wheel defines, in particular with the axis of rotation thereof, a rotational axis, wherein the wheel preferably rotates about the rotational axis during driving operation. In particular, the wheel is rotatably mounted on a wheel axle. In particular, the wheel axle is a fixed axle that is firmly connected and/or connectable to a frame or a wheel fork of the vehicle. For example, the wheel axle is designed as a quick-release axle.

The brake device has a brake body device which is designed and/or suitable for transmitting a brake force to the wheel, in particular a wheel rim. In particular, the rotating wheel can be braked and/or stopped by introducing the brake force. The brake force is preferably to be understood as a force which brakes the rotating wheel rim by means of friction while the force is applied. For example, the brake force can be understood as a clamping force of the brake body device against the wheel rim in the axial direction with respect to the wheel axle. The brake body device is preferably designed as a rotationally symmetrical and/or plate-shaped disc or annular disc. The brake body device can be made of a solid material, for example metal, in particular aluminum.

The brake device has a concentric brake cylinder which is designed and/or suitable for generating the brake force. In particular, the brake cylinder is designed as a hydraulically actuable brake cylinder. For this purpose, the brake body device and the brake cylinder are preferably arranged to be coaxial and/or concentric to one another with respect to the rotational axis. The brake cylinder and/or the brake body device can be arranged on the wheel axle, preferably in a non-rotatable manner. In particular, the brake cylinder is arranged and/or received radially inside the brake body device designed as an annular disc.

The brake cylinder has an inner housing part for radial support on the wheel axle and an outer housing part for axial support on the brake body device. In particular, the inner and outer housing parts together form an annular housing which runs around the rotational axis. The inner housing part is preferably connected to the wheel axle in a non-rotatable manner. For this purpose, the inner housing part can have a central through opening through which the wheel axle is guided or inserted. The outer housing part is preferably operatively connected to the brake body device to transmit the brake force.

The two housing parts can be moved relative to one another. In particular, the outer housing part is displaceable relative to the inner housing part in the axial direction with respect to the rotational axis, wherein the inner housing part preferably remains stationary on the wheel axle. In particular, the brake body device can be moved axially together with the outer housing part. The outer housing part preferably transmits the brake force in the form of kinetic energy to the brake body device by displacing the brake body device axially towards the wheel, in particular the wheel rim, so that the brake body device rests against the wheel rim and/or is pressed against the wheel rim to brake the rotating wheel.

A pressure chamber running around the rotational axis is formed between the two housing parts. The pressure chamber is preferably designed as an annular chamber. In particular, the pressure chamber is filled with a fluid, for example, a hydraulic fluid, wherein the two housing parts are displaced relative to one another when there is a change in the fluid pressure of the fluid in the pressure chamber. The brake cylinder is preferably designed as a slave cylinder, wherein the pressure chamber is fluidically connectable and/or connected to a master cylinder for this purpose via a fluid connection, in particular via a fluid line. When the master cylinder is actuated, a column of fluid is displaced via the fluid line in the direction of the pressure chamber, wherein the column of fluid that can be supplied displaces the outer housing part axially, so that the outer housing part transmits the brake force to the brake body device by a stroke movement. For example, the master cylinder can be actuated via a brake lever or a brake pedal. It can optionally be provided that a resetting mechanism is arranged between the two housing parts to reset the housing parts into a release position and/or to hold them in this position when the master cylinder is not actuated. In particular, the resetting mechanism generates a restoring force that counteracts the hydraulic brake force that is generated in the pressure chamber.

In the context of the disclosure, it is proposed that the brake device has an insulation device which is designed and/or suitable for the thermal insulation of the brake body device in the direction of the brake cylinder. The insulation device is arranged axially between the outer housing part and the brake body device. In particular, the insulation device has the function of insulating the brake cylinder, in particular neuralgic contact points between the outer housing part and the brake body device, against the conduction of braking heat that is generated with and/or during the introduction of the brake force into the wheel. The insulation device preferably has a thermal conductivity coefficient which is significantly lower than a thermal conductivity coefficient of the material of the brake body device and/or of the outer housing part. For example, the insulation device has a thermal conductivity coefficient of less than 10 W/(m*K), preferably less than 1 W/(m*K), more specifically less than 0.5 W/(m*K). In particular, the insulation device is formed by a thermally insulating composite material, preferably made of an organic and/or inorganic material and/or a heat-resistant plastic and/or a ceramic.

An advantage of the disclosure consists in particular in the fact that the neuralgic contact points between the outer housing component and the brake body device, in particular as a heat-sensitive component of the brake device, are protected from the braking heat. In addition, sensitive components inside the concentric brake cylinder can be thermally insulated to prevent damage to the system. As a result, the risk of overheating and damage or operational failures of the brake device caused thereby can be avoided, so that the operational reliability of the brake device can be significantly increased.

In a specific embodiment, it is provided that the insulation device has an annular insulation section. In particular, the annular insulation section is designed as an annular disc. The annular insulation section is preferably arranged coaxially to the brake cylinder and/or the brake body device with respect to the rotational axis. In particular, the annular insulation section is centered on the outer housing part and/or the brake body device in order in particular to ensure a secure and/or correctly positioned seat. In principle, the annular insulation section is designed in one piece.

According to this embodiment, the annular insulation section rests against the brake body device in an axial direction and against the outer housing part in an axial opposite direction. In particular, the annular insulation section rests flat on the brake body device and/or the outer housing part, preferably over the entire surface. The outer housing part preferably transmits the brake force to the brake body device with the interposition of the annular insulation section. In particular, a heat path is interrupted by the annular insulation section, which heat path runs from the brake body device as a heat-dissipating component in the direction of the outer housing part as a heat-sensitive component.

An insulation device is thus proposed which implements an interruption of the heat path between the brake body device and the outer housing part in a simple and inexpensive manner.

In an alternative configuration, the insulation device has at least or precisely one insulation section in the shape of a circular ring segment. In particular, the insulation section in the shape of a circular ring segment is designed as a circular ring segment of an annular disc. Preferably, the insulation section in the shape of a circular ring segment is and/or can be arranged on a partial circle lying concentrically to the rotational axis with respect to the rotational axis. In particular, the insulation section in the shape of a circular ring segment is centered on the outer housing part and/or the brake body device in particular to ensure a secure and/or correctly positioned seat.

According to this embodiment, the insulation section in the shape of a circular ring segment rests against the brake body device in an axial direction and against the outer housing part in an axial opposite direction. In particular, the insulation section in the shape of a circular ring segment rests flat on the brake body device and/or the outer housing part, preferably over the entire surface. The outer housing part preferably transmits the brake force to the brake body device with the insulation section in the shape of a circular ring being interposed, wherein the brake body device and the outer housing part are spaced apart from one another outside the insulation section in the shape of a circular ring segment viewed in the circumferential direction. In particular, a heat path is interrupted by the insulation section in the shape of a circular ring segment, which runs from the brake body device as a heat-dissipating component in the direction of the brake cylinder as a heat-sensitive component.

An alternative insulation device is thus proposed, which implements an interruption of the heat path between the brake body device and the outer housing part in a simple and inexpensive manner and is also easy to assemble.

In a specific further development, it is provided that the insulation device has at least or precisely one further insulation section in the shape of a circular ring segment. The insulation device is preferably formed in several parts, wherein the insulation sections in the shape of a circular ring segment form an annular insulation component as the insulation device. In particular, the several circular ring segments are combined to form a circle in the circumferential direction for this purpose. In principle, the circular ring segments can be connected to one another in a form-fitting and/or force-fitting and/or material-fitting manner. Alternatively, the circular ring segments are supported on one another in the circumferential direction via a butt joint or are slightly spaced apart from one another via an air gap. In particular, the insulation device has more than two, preferably more than four, in particular more than six, of the insulation sections in the shape of a circular ring segment, which are assembled and/or can be assembled to form a circle in the circumferential direction.

It is therefore a consideration of the disclosure to propose an insulation device which is particularly easy to assemble. Due to the individual circular ring segments, the insulation device can be retrofitted into an already installed brake device without needing to remove individual components. In addition, the brake force can be transmitted uniformly to the brake body device due to the circular arrangement of the insulation sections in the shape of circular ring segments.

In a further embodiment it is provided that the inner housing part has a support contour and the brake body device has a counter-contour complementary to the support contour. The support contour and the counter-contour are in engagement with one another to support the torque of the brake body device. In particular, the support contour defines a kind of lever arm to absorb a moment about the wheel axle. The brake body device is preferably connected to the inner housing part, in particular the support contour, in a non-rotatable manner and movably in the axial direction via the counter-contour.

In principle, the inner housing part can be formed by a housing component delimiting the pressure chamber, e.g., a hub, and a support component carrying the support contour, e.g., a support ring, wherein the housing and the support component are connected to one another in a non-rotatable manner via the wheel axle. Alternatively, however, the support contour can also be formed directly onto the housing component, wherein the housing component and the support contour are made from a common material section, in particular in one piece.

According to this embodiment, the insulation device has at least or precisely one axial insulation section, wherein the support contour and the counter-contour are thermally insulated from one another via the axial insulation section. The axial insulation section is preferably used for thermal insulation in the circumferential direction between the support contour and the counter-contour. In particular, the axial insulation section extends for this purpose in the axial direction between the support contour and the counter-contour. The axial insulation section is preferably designed as a flat, in particular plate-shaped, web. Particularly preferably, the axial insulation section is formed onto the annular insulation section or the insulation section in the shape of a circular ring segment and/or is manufactured in one piece, in particular from a common material section, and is connected thereto. In particular, the axial insulation section rests against the supporting contour and/or the counter-contour in the circumferential direction, preferably flat. The brake body device preferably transmits the braking torque to the inner housing section with the axial insulation section being interposed. In particular, the axial insulation section interrupts a heat path which runs from the brake body device as a heat-dissipating component in the direction of the inner housing part as a heat-sensitive component.

An insulation device is thus proposed which implements an interruption of the heat path between the brake body device and the inner housing part in a simple and inexpensive manner.

In a further specification it is provided that the support contour is formed by at least or precisely one support vane directed radially outwards. In particular, the support contour comprises more than two, preferably more than four, in particular more than six, of the support vanes, wherein the support vanes are distributed uniformly around the rotational axis in the circumferential direction. The counter-contour is preferably formed by recesses correspondingly introduced into the brake body device, in particular axially running grooves. In particular, the support vanes are arranged on an outer circumference of the inner housing part and the recesses are arranged on an inner circumference of the brake body device.

According to this embodiment, the insulation device has exactly two of the insulation sections for each support vane, wherein the respective two insulation sections encompass the support vane on both sides. In particular, the support vane is arranged in a form-fitting manner in the circumferential direction between the two associated insulation sections. In particular, each of the insulation sections in the shape of a circular ring segment is assigned two of the axial insulation sections, wherein the two axial insulation sections together encompass a support vane or each encompass a support vane with an adjacent further axial insulation section of an adjacent insulation section in the shape of a circular ring segment. Each of the support vanes is particularly preferably insulated on both sides by an axial insulation section in the circumferential direction.

In a further embodiment, it is provided that the brake body device has a cooling structure on an outer side, which is designed and/or suitable for dissipating the braking heat by means of convection. In particular, the cooling structure has the function of dissipating braking energy out from the brake device in the form of frictional heat. The cooling structure is preferably arranged on a side of the brake body device which faces away from the wheel. For example, the cooling structure has a number of elongate or swirl-shaped cooling ribs.

A brake body device is thus proposed which dissipates a large part of the braking heat to the environment by means of convection. In this way, the transmission of braking heat to the temperature-sensitive components of the brake cylinder can be further reduced.

In a further specification, it is proposed that the outer housing part be designed as a hollow-cylindrical piston and the inner housing part as a hollow-cylindrical hub for receiving the wheel axle. In particular, the piston is designed as a stepped annular piston, which is supported in a form-fitting manner in the radial direction on an outer circumference of the hub. Preferably the hub is received radially inward of the piston. A first part of the pressure chamber is preferably delimited by the piston and a second part of the pressure chamber is delimited by the hub. The piston is linearly displaceable on the hub to act against the brake body device. The piston is preferably linearly guided on the hub to carry out the axial stroke movement.

A brake cylinder is thus proposed which is characterized by a particularly simple and compact structure. In addition, the brake cylinder can be designed to be particularly robust.

In a further development it is provided that the piston has a first and a second piston section and the hub has a first and a second hub section. In particular, the two piston sections have different inner diameters, so that the stepped annular piston is formed. Specifically, the piston is formed in a Z-shape when viewed in cross-section. In particular, the two hub sections have different outer diameters, so that the hub is designed to be complementarily stepped to the stepped annular piston.

The first piston section and the first hub section are thus radially offset with respect to the second piston section and the second hub section, so that an offset defining the pressure chamber is created. In particular, the offset created on the piston delimits the pressure chamber in the axial direction and the offset created on the hub delimits the pressure chamber in the axial opposite direction. The first piston section and the first hub section and the second piston section and the second hub section are supported on one another in a sealing manner in the radial direction. At least one sealing means is preferably arranged between the first piston section and the first hub section and between the second piston section and the second hub section to seal the pressure chamber in a fluid-tight manner. The sealing means are particularly preferably optionally arranged in grooves of the piston and/or the hub. It is particularly preferred that the insulation device is supported radially on an outer circumference of the piston section offset radially inwards and/or is supported axially on an annular surface of the piston formed by the offset.

A further object of the disclosure relates to a vehicle having the brake device as previously described. In particular, the vehicle is formed as a single or multi-track vehicle. Preferably, the vehicle is formed as an electrically powered vehicle. Preferably, the vehicle is formed as a small or micro vehicle or as an electric vehicle. With only one wheel, the vehicle can be formed as an electric unicycle, for example, what is termed a monowheel or solowheel. With two or more wheels, the vehicle is preferably formed as an electric two-wheeler, in particular an electric motorcycle, electric motor scooter, an electric scooter, electric pedal scooter, for example, e-scooter, segway, hoverboard, kickboard, skateboard, longboard, or the like. Alternatively, the vehicle can be formed as a bicycle, in particular as an electric bicycle, for example as a pedelec or as an e-bike. The vehicle can alternatively be formed as a multi-track bicycle, in particular with three or more wheels. For example, the vehicle may be a transport or cargo bike, in particular a motorized or electrically powered transport or cargo bike, more specifically a three-wheeled or four-wheeled pedelec or a rickshaw, in particular with or without a roof, or a cabin scooter.

### BRIEF DESCRIPTION OF THE DRAWINGS

Further features, advantages, and effects of the disclosure are set out in the following description of the preferred exemplary embodiments. In the figures:

FIG. 1 shows a vehicle with two wheels, wherein the vehicle is designed as an electric scooter;

FIG. 2 shows a schematic sectional view of the brake device of the vehicle according to FIG. 1 as an exemplary embodiment;

FIGS. 3A and 3B show different perspective views of the brake device according to FIG. 2;

FIGS. 4A and 4B show two alternative versions of an insulation device for the brake device according to FIG. 2.

### DETAILED DESCRIPTION

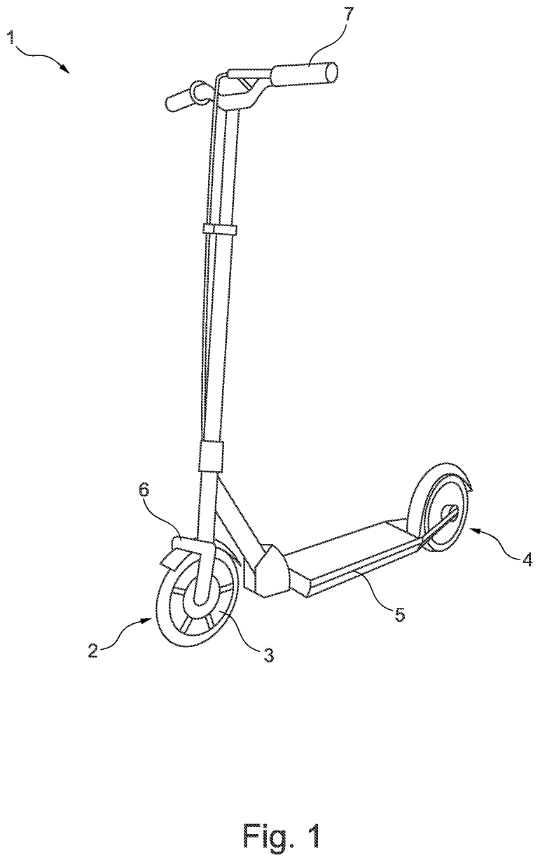

FIG. 1 shows a three-dimensional representation of a vehicle 1, wherein the vehicle 1 is formed as an electric motorcycle, electric pedal scooter or electric scooter, also known as an e-scooter. The vehicle 1 has a wheel module 2 having a wheel 3, which forms a front wheel of the vehicle 1. The wheel module 2 is used in particular for the electric drive of the vehicle 1. In addition, the vehicle 1 has a rear wheel 4, in particular a non-powered rear wheel, which is rotatably mounted on a vehicle frame 5 of the vehicle 1.

The vehicle 1 has a wheel fork 6, wherein the wheel module 2 is rotatably mounted in the wheel fork 6. The wheel fork 6 is pivotally connected to the frame 5 via handlebars 7, so that the wheel module 2 can be pivoted via the handlebars 7 to steer the vehicle 1.

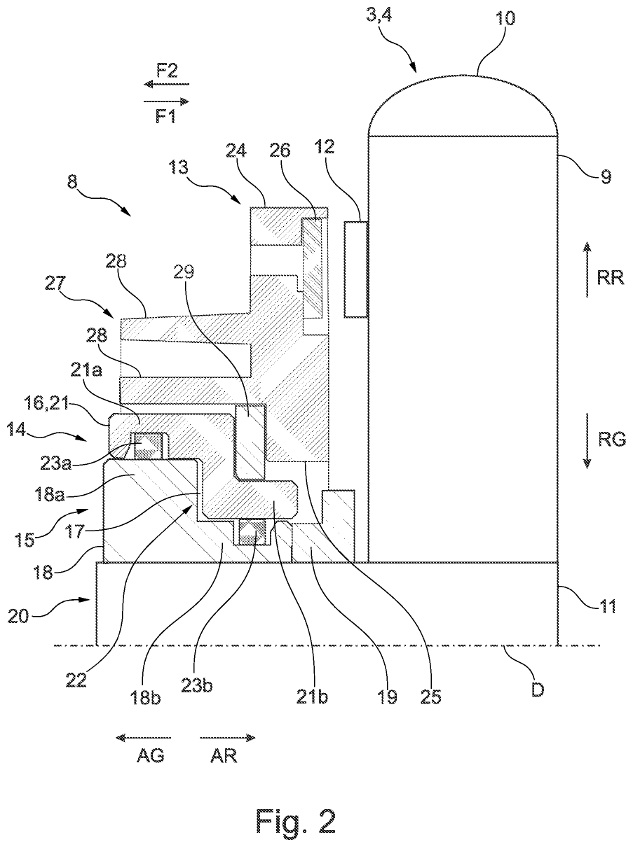

FIG. 2 shows, in a schematic sectional illustration, a brake device 8 which is designed and/or suitable for the wheel module 2 or for the rear wheel 4 according to FIG. 1. The wheel 3, 4 has a wheel rim 9 and a tire 10, wherein the tire 10 is arranged on the wheel rim 9. For example, the wheel rim 9 is formed as a steel, aluminum, or plastic rim. For example, the tire 10 is formed as a rubber tire filled with air.

The module 3, 4 has a wheel axle 11, which defines a rotational axis D with the longitudinal axis thereof. The wheel rim 8 is, for example, supported rotatably on the wheel axle 11 via bearing devices, not shown, wherein the wheel axle 11 is fixed, for example, on the wheel fork 6 in the case of the front wheel.

The brake device 8 is designed as a friction brake, which is arranged on one side of the wheel rim 9 to transmit a braking torque. The brake device 8 has an annular brake pad 12, in particular one that encircles the rotational axis D, and a brake body device 13 designed as a brake disc. The brake pad 12 and the brake body device 13 are arranged to be coaxial to one another with respect to the rotational axis D. The brake pad 12 is mounted in a non-rotatable manner with respect to the rotational axis D on an axial end face of the wheel rim 9, so that the brake pad 12 is carried along by the wheel rim 9 during driving operation and rotates about the rotational axis D. The brake body device 13 is movable in an axial direction AR towards the brake pad 12 and in an axial opposite direction AG away from the brake pad 12.

Further, the brake device 8 includes a concentric brake cylinder 14 for transmitting a brake force F1 to the brake body device 13. The brake cylinder 14 can be actuated hydraulically, for example, wherein the brake cylinder 14 is designed as what is termed a slave cylinder for this purpose and is fluidically connected to a master cylinder, not shown, via a hydraulic path.

The brake cylinder 14 has an inner and an outer housing part 15, 16, wherein the housing parts 15, 16 are arranged concentrically with respect to the rotational axis D and are displaceable and/or rotatable relative to one another in the axial direction. The two housing parts 15, 16 together form an annular housing running around the rotational axis D, wherein a pressure chamber 17 running around the rotational axis D is formed between the two housing parts 15, 16. The pressure chamber 17 is filled with a fluid, for example with a hydraulic oil, and is fluidically connected to the master cylinder via a fluid line, not shown, to form the hydraulic path.

The inner housing part 15 has a hollow-cylindrical hub 18 as a housing component and a support ring 19 as a support component. In particular, the hub 18 and the support ring 19 are supported on one another in the axial direction and are coupled to one another in a non-rotatable manner via the wheel axle 11. For this purpose, the hub 18 and the support ring 19 each have a through opening 20 through which the wheel axle 11 is guided or inserted. The support ring 19 serves to support the torque of the brake body device 13, wherein the brake body device 13 is supported on the support ring 19 in the circumferential direction about the rotational axis D for this purpose, so that torques acting on the brake body device 13 are introduced into the wheel axle 11 via the support ring 19.

The outer housing part 16 is designed as a hollow-cylindrical piston 21, which is arranged to be coaxial and/or concentric to the hub 18 and is supported radially on the outer circumference thereof. The piston 21 is designed as a stepped annular piston and for this purpose has a first and a second piston section 21a, b, which are radially offset from one another. Viewed in a cross-section, the piston 21 is therefore stepped, in particular Z-shaped. The hub 18 forms a counterpart that is complementary to the piston 21 and for this purpose has a first and a second hub section 18a, b, which are radially offset from one another corresponding to the two piston sections 21a, b. Thus, in each case a radial offset 22 is formed on the hub 18 and the piston 21, which delimits the pressure chamber 17 in the axial direction AR and in the axial opposite direction AG. The pressure chamber 17 is also delimited in a radial direction RR by the first piston section 21a and in a radial opposite direction RG by the second hub section 18b.

The first piston section 21a is supported radially on the first hub section 18a via a first sealing means 23a, wherein the first sealing means 23a is received in an annular groove made in the first piston section 21a. The second piston section 21b is supported radially on the second hub section 18b via a second sealing means 23b, wherein the second sealing means 23b is arranged in an annular groove made in the second hub section 18b.

The brake body device 13 has a pressure plate 24 which serves to transmit the brake force F1 to the friction lining 12. The pressure plate 24 is designed as an annular disc and is arranged to be coaxial and/or concentric with respect to the rotational axis D with respect to the brake cylinder 14. For this purpose, the pressure plate 24 has a central opening 25, wherein the brake cylinder 14 is guided therethrough in sections. In addition, the brake body device 13 has an annular contact plate 26, for example a steel plate, which is arranged on an axial end face of the pressure plate 24 facing the wheel rim 9. The contact plate 26 is used to make contact with the brake pad 12 and, as a wear part, can be replaced in a simple manner.

When the brake device 8 is actuated, a fluid column is displaced from the master cylinder toward the brake cylinder 14, wherein fluid flows into the pressure chamber 17 and fluid pressure is applied to the piston 21. The piston 21 then performs a stroke in the axial direction AR and transmits the brake force F1 generated by the fluid pressure to the brake body device 13, especially the pressure plate 24. This causes the brake body device 13 to be displaced in the axial direction AR, and to be applied to and/or pressed against the brake pad 16.

In the actuated state of the brake device 8, the contact plate 26 of the brake body device 13 contacts the brake pad 16 so that the braking torque is formed by a frictional connection to brake the rotating wheel 3, 4 by friction between the contact plate 26 and the brake pad 12. When the brake device 8 is released, the fluid column is displaced again in the direction of the master cylinder so that the brake body device 13 is moved and/or is movable away from the brake pad 12 in the axial opposite direction AG. For this purpose, the brake device 8 can have, for example, a resetting mechanism, not shown, which applies a restoring force F2 to the brake body device 13 and the piston 21 in the axial opposite direction AG.

Depending on the requirements, high, sustained temperatures are generated in the brake device 8. For example, these temperatures can develop on the brake body device 13 during heavy braking. This can have a negative effect on heat-sensitive components inside the concentric brake cylinder 14, so that this must be thermally insulated to avoid damaging the system.

For this purpose, the brake body device 13 has a cooling structure 27 on one side on an axial end face facing away from the wheel rim 9. The cooling structure 27 has a plurality of cooling ribs 28 for exchanging thermal energy of the brake body device 13 with an environment, for example ambient air. The braking heat generated during braking can thus be largely dissipated to the environment via the cooling structure 28 of the pressure plate 24 by convection. Nevertheless, the braking heat can also be partially passed on to the components of the brake cylinder 14.

To protect these components, an insulation device 29 is arranged axially between the piston 21 and the pressure plate 24, which insulates the brake cylinder 14 from the brake body device 24. Thus, the braking heat is not passed on to the piston 21, so that damage to the brake cylinder 14 caused by the effect of heat is prevented. For example, the insulation device 29 has a material which is characterized by a particularly low heat transfer coefficient compared to the pressure plate 24. The pressure plate 24 is made of aluminum or an aluminum alloy, for example. The insulation device 29 is made of a composite material, for example, which has, for example, organic and/or inorganic components such as sand, stone, lime, or the like. Alternatively or optionally in addition, however, the insulation device 29 can also be made of a heat-resistant plastic or ceramic.

The insulation device 29 is preferably designed to be annular. The insulation device 29 is supported in the radial direction RR on an inner circumference of the pressure plate 24 and in the opposite radial direction RG on an outer circumference of the second piston section 21b. In the axial direction AR, the insulation device 29 rests against the pressure plate 24 and in the axial opposite direction AG against a shoulder of the piston 21 formed by the offset 22. The brake force F1 acting on the piston 21 is thus transmitted to the pressure plate 24 with the insulation device 29 being interposed.

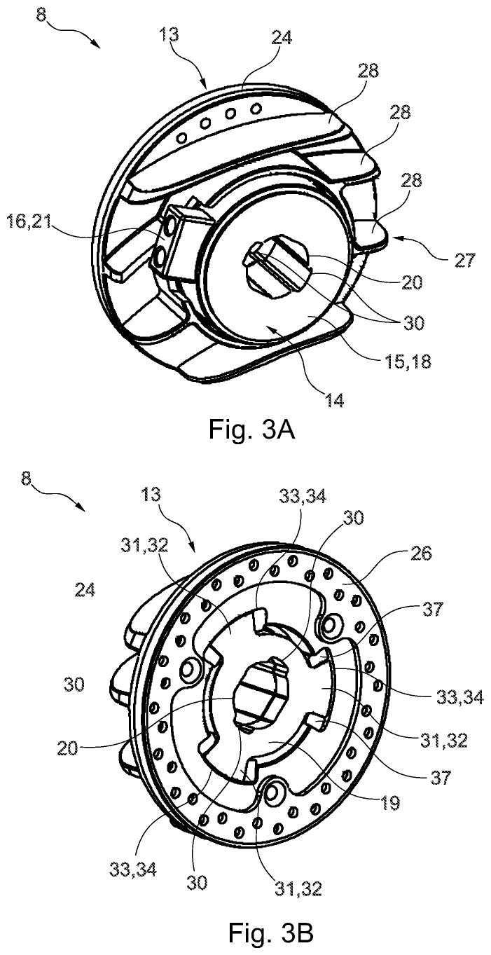

FIGS. 3A and 3B each show the brake device 8 according to FIG. 2. The brake device 8 is shown in FIG. 3A in a perspective view from the rear and in FIG. 3B in a perspective view from the front. The hub 18 and the support ring 19 each have two diametrically arranged depressions 30 which are introduced into the inner circumference of the through openings 20 and extend in the axial direction. The wheel axle 11, as shown in FIG. 2, can have corresponding elevations, wherein the wheel axle 11 is inserted into the through opening 20 during assembly and engages via the elevations in the depressions 30, so that the hub 18 and the support ring 19 on the wheel axle 11 are secured against twisting.

As shown in FIG. 3B, the support ring 19 has a support contour 31 for torque support, which is formed by support vanes 32 projecting radially outward. On the inner circumference thereof, the pressure plate 24 has a counter-contour 33 which is complementary to the support contour 31 and is formed by radially introduced grooves 34 as recesses. Each of the support vanes 32 is in engagement with one of the grooves 34, wherein the pressure plate 24 is arranged on the support contour 31 so as to be longitudinally displaceable in the axial direction and non-rotatable in the circumferential direction.

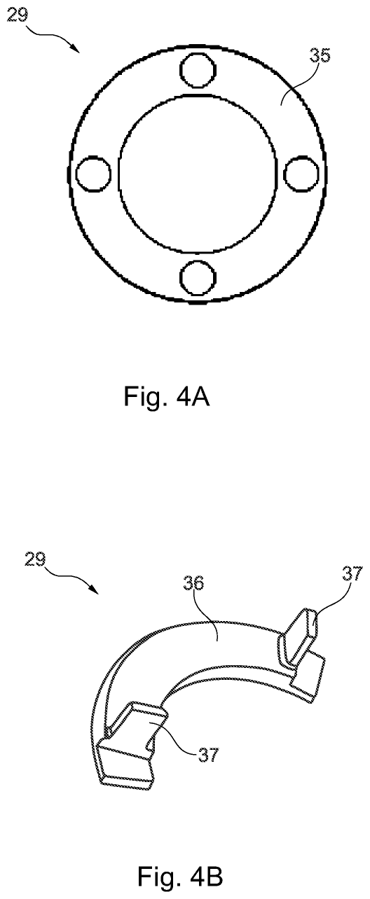

FIGS. 4A and 4B each show the insulation device 29 according to FIG. 2. FIG. 4A shows the insulation device 29 in an axial view as a first exemplary embodiment. The insulation device 29 is formed by an annular insulation section 35, which can be pushed coaxially with respect to the rotational axis D onto the second cylinder section 18b. The annular insulation section 35 can rest flat against the piston 21 and/or the pressure plate 24. In particular, thermal insulation is implemented in the axial direction and a heat path running between piston 21 and pressure plate 24 is interrupted.

FIG. 4B shows the insulation device 29 in a perspective view as a second exemplary embodiment. The insulation device 29 has an insulation section 36 in the shape of a circular ring segment and two axial insulation sections 37 protruding in the axial direction, which directly adjoin the insulation section 36 in the shape of a circular ring segment. In particular, several of the insulation sections 36 in the shape of circular ring segments can be combined to form an annular insulation component.

The axial insulation sections 37 are designed as plate-shaped webs which can be arranged between the supporting contour 31 and the counter-contour 33. Here, insulation sections 36 rest in the circumferential direction around the rotational axis on one of the support vanes 32 and/or one of the grooves 34 in each case. In particular, a thermal insulation in the axial direction is thus implemented by the insulation section 36 in the shape of a circular ring segment, and a heat path running between the pressure plate 24 and the piston 21 is interrupted. In addition, thermal insulation is implemented in the circumferential direction by the axial insulation sections 37 and a heat path running between the pressure plate 24 and the support ring 19 is interrupted. In addition, the axial insulation sections 36 can assume the function of a guide sleeve or sliding sleeve.

### LIST OF REFERENCE SYMBOLS

1 Vehicle

2 Wheel module

3 Wheel

4 Rear wheel

5 Frame

6 Wheel fork

7 Handlebars

8 Brake device

9 Wheel rim

10 Tire

11 Wheel axle

12 Brake pad

13 Brake body device

14 Brake cylinder

15 Inner housing part

16 Outer housing section

17 Pressure chamber

18 Hub

18a, b Hub sections

19 Support ring

20 Through opening

21 Piston

21a, b Piston sections

22 Offset

23a, b Sealing means

24 Pressure plate

25 Opening

26 Contact plate

27 Cooling structure

28 Cooling ribs

29 Insulation device

30 Depressions

31 Support contour

32 Support vanes

33 Counter-contour

34 Grooves

35 Annular insulation section

36 Insulation section in the shape of a circular ring segment

37 Axial insulation section

D Rotational axis

AR Axial direction

AG Axial opposite direction

RR Radial direction

RG Radial opposite direction

1. A brake device for a vehicle with at least one wheel, wherein the wheel defines a rotational axis, the brake device comprising:
a brake body device configured for transmission of a brake force to the wheel;
a concentric brake cylinder configured for generation of the brake force;
the brake cylinder has an inner housing part configured for radial support on a wheel axle of the wheel and an outer housing part configured for axial support on the brake body device;
the two housing parts are moveable relative to one another; is formed between the two housing parts; and
an insulation device for thermal insulation of the brake body device in a direction of the brake cylinder, wherein the insulation device is arranged at least axially between the outer housing part and the brake body device.

2. The brake device according to claim 1, wherein the insulation device has an annular insulation section, and the annular insulation section rests against the brake body device in an axial direction and against the outer housing part in an axial opposite direction.

3. The brake device according to claim 1, wherein the insulation device has at least one insulation section shaped as a circular ring segment, and the insulation section shaped as the circular ring segment rests against the brake body device in an axial direction and against the outer housing part in an axial opposite direction.

4. The brake device according to claim 3, wherein the insulation device has at least one further insulation section shaped as a second circular ring segment, and the insulation section and the at least one further insulation section together form an annular insulation component.

5. The brake device according to claim 1, wherein the inner housing part has a supporting contour and the brake body device has a counter-contour complementary to the supporting contour and the insulation device has at least one axial insulation section, wherein the support contour and the counter-contour are in engagement with one another to support a torque of the brake body device and are thermally insulated from one another via the axial insulation section.

6. The brake device according to claim 5, wherein the support contour has at least one support vane directed radially outwards, and the insulation device has two of the axial insulation sections for each said support vane, which encompass the support vane on both sides. The brake device according to claim 1, wherein the brake body device has a cooling structure on an outer side thereof for dissipating the braking heat by convection.

8. The brake device according to claim 1, wherein the outer housing part has a hollow-cylindrical piston and the inner housing part has a hollow-cylindrical hub for receiving the wheel axle, and the piston is linearly displaceable on the hub to act against the brake body device.

9. The brake device according to claim 8, wherein the piston has a first and a second piston section and the hub has a first and a second hub section each of the first piston section and the first hub section as well as the second piston section and the second hub section are sealingly supported on one another in a radial direction, and the first piston section and the first hub section are radially offset to the second piston portion and the second hub portion so that an offset defining the pressure chamber is created.

10. A vehicle comprising the brake device according to claim 1, wherein the vehicle is a small electric vehicle.

11. A brake device for a vehicle with at least one wheel, wherein the wheel defines a rotational axis, the brake device comprising:
an axially movable brake body configured for transmission of a brake force to a brake pad on the wheel;
a concentric brake cylinder configured for generation of the brake force;
the brake cylinder having an inner housing part configured for radial support on a wheel axle of the wheel and an outer housing part configured for radial support on the inner housing part and axial support against the brake body;
the two housing parts are axially moveable relative to one another;
a pressure chamber that extends at least partially around the rotational axis formed between the inner and outer housing parts; and
an insulator for thermal insulation of the brake body in a direction of the brake cylinder arranged at least axially between the outer housing part and the brake body.

12. The brake device according to claim 11, wherein the insulator has an annular insulation section, and the annular insulation section rests against the brake body in an axial direction and against the outer housing part in an axial opposite direction.

13. The brake device according to claim 11, wherein the insulator comprises at least one insulation section shaped as a circular ring segment, and the insulation section rests against the brake body in an axial direction and against the outer housing part in an axial opposite direction.

14. The brake device according to claim 13, wherein the insulator has at least one further insulation section shaped as a second circular ring segment, and the insulation section and the at least one further insulation section together form an annular insulation component.

15. The brake device according to claim 11, wherein the inner housing part has a supporting contour and the brake body has a counter-contour complementary to the supporting contour and the insulator has at least one axial insulation section, wherein the support contour and the counter-contour are in engagement with one another to support a torque of the brake body and are thermally insulated from one another via the axial insulation section.

16. The brake device according to claim 15, wherein the support contour has at least one support vane directed radially outwards, and the insulator has two of the axial insulation sections for each said support vane, which encompass the support vane on both sides.

17. The brake device according to claim 11, wherein the brake body has a cooling structure on an outer side thereof for dissipating the braking heat by convection.

18. The brake device according to claim 11, wherein the outer housing part has a hollow-cylindrical piston and the inner housing part has a hollow-cylindrical hub for receiving the wheel axle, and the piston is linearly displaceable on the hub to act against the brake body.

19. The brake device according to claim 18, wherein the piston has a first and a second piston section and the hub has a first and a second hub section, each of the first piston section and the first hub section as well as the second piston section and the second hub section are sealingly supported on one another in a radial direction, and the first piston section and the first hub section are radially offset to the second piston portion and the second hub portion so that an offset defining the pressure chamber is created.

20. A vehicle comprising the brake device according to claim 11 and a wheel having an axle on which the braking device is located.
